(19) United States
(12) Patent Application Publication
(10) Pub. No.: US 2009/0212581 A1
(43) Pub. Date: Aug. 27, 2009

(54) FORWARD FOLDING VEHICLE GRILL GUARD

(75) Inventor: Jeremy Jon Drever, Des Moines, IA (US)

Correspondence Address: STANDLEY LAW GROUP LLP, 6300 Riverside Drive, Dublin, OH, 43017, US

(73) Assignee: PRO METAL INDUSTRIES LTD., Regina (CA)

(21) Appl. No.: 12/236,199

(22) Filed: Sep. 23, 2008

Related U.S. Application Data
(60) Provisional application No. 61/021,087, filed on Jan. 15, 2008.

(51) Int. Cl. B60R 19/52; E05B 65/12

(52) U.S. Cl. 293/115; 70/258

(57) ABSTRACT

A grill guard apparatus for a vehicle with a bumper includes a grill guard pivotally attached at a bottom portion thereof to the bumper about a horizontal pivot axis located vertically between top and bottom edges of the bumper such that the grill guard can pivot about the pivot axis from an upright raised position in front of the vehicle grill to a lowered position extending horizontally forward from the bumper. Portions of the grill guard above the pivot axis bear against the bumper above the pivot axis when the grill guard is in the raised position, and portions of the grill guard below the pivot axis bear against the bumper below the pivot axis when the grill guard is in the lowered position and thereby support the grill guard in the lowered position. A lock mechanism is operative to maintain the grill guard in the raised position.

### CROSS-REFERENCE TO RELATED APPLICATIONS

This application claims the benefit of U.S. Provisional Application No. 61/021,087, filed Jan. 15, 2008, which is hereby incorporated by reference in its entirety.

### TECHNICAL FIELD

This invention is in the field of vehicles, primarily trucks, and in particular a forward folding grill guard for protecting the front end of the vehicle.

### BACKGROUND OF THE ART

The front end of a vehicle typically includes a grill with openings to allow air to flow through into the radiator. These grills are typically not particularly robust and can be relatively easily damaged. Grill covers or protectors are therefore popular. These typically are fixed to the bumper or front end of the frame and extend upward to cover the grill and protect it from damage.

Such grill covers can interfere with maintenance and the like required to be performed on the vehicle. For example in large trucks such as highway tractors it is common to have a vehicle hood and grill combination that folds forward to open the engine compartment for access. In this case the common prior art grill guard must be removed to open the hood. It is also known to provide a grill guard that is attached to the bumper of the truck, and where the bumper is pivotally attached to the truck frame such that the grill guard and bumper can be folded forward together. The grill and bumper and frame must be structured to resist shock loading on the grill guard from contact with wild life or the like, and consequently the combination of bumper and grill guard is quite heavy and cumbersome, and not easily maneuvered.

### SUMMARY OF THE INVENTION

It is an object of the present invention to provide a forward folding grill guard apparatus that overcomes problems in the prior art.

In a first embodiment the present invention provides a grill guard apparatus for attachment to a bumper of a vehicle to protect a grill of the vehicle. The apparatus comprises a grill guard adapted to be pivotally attached at a bottom portion thereof to the bumper about a substantially horizontal pivot axis such that the grill guard can pivot about the pivot axis from an upright raised position in front of the vehicle grill to a lowered position extending substantially horizontally forward from the bumper. The pivot axis is located vertically between top and bottom edges of the bumper and the grill guard is configured such that portions of the grill guard above the pivot axis bear against the bumper above the pivot axis when the grill guard is in the raised position, and such that portions of the grill guard below the pivot axis bear against the bumper below the pivot axis when the grill guard is in the lowered position and thereby support the grill guard in the lowered position. A lock mechanism is operative to maintain the grill guard in the raised position.

In a second embodiment the present invention provides a grill guard apparatus for a vehicle to protect a grill of the vehicle. The apparatus comprises a bumper attached to the front end of the vehicle such that same extends across the lower front portion of the vehicle below the grill. A grill guard is pivotally attached at a bottom portion thereof to the bumper about a substantially horizontal pivot axis located vertically between top and bottom edges of the bumper such that the grill guard can pivot about the pivot axis from an upright raised position in front of the vehicle grill to a lowered position extending substantially horizontally forward from the bumper. The grill guard is configured such that portions of the grill guard above the pivot axis bear against the bumper above the pivot axis when the grill guard is in the raised position, and such that portions of the grill guard below the pivot axis bear against the bumper below the pivot axis when the grill guard is in the lowered position and thereby support the grill guard in the lowered position. A lock mechanism is operative to maintain the grill guard in the raised position.

In a third embodiment the present invention provides a lock apparatus for locking a first member to a second member. The apparatus comprises a catch rod mounted to the first member and a latch mechanism mounted to the second member. The latch mechanism comprises a catch member and a rotatable handle configured such that when the handle is in an open position, the catch member is in an open position with a face of the catch member adjacent to the catch rod and a lip of the catch member is located on a side of the catch rod opposite to the latch mechanism, and configured such that when the handle is rotated to a locked position, the catch member moves toward the latch mechanism so that the lip engages the catch rod.

The present invention provides a bumper adapted to be rigidly attached to the front end of a vehicle frame such that same extends across the lower front portion of the vehicle, typically a large truck such as a highway tractor or the like. A grill guard is pivotally attached to the bumper about a substantially horizontal pivot axis that is located vertically about mid way between the top and bottom of the bumper. The pivot axis is conveniently provided by right and left pivot brackets welded to the bumper, with pins extending through the brackets and through the bottom ends of corresponding right and left vertical guard members.

The bottom ends of the vertical guard members and the pivot brackets are configured such that portions of the vertical guard members above the pivot axis bear against the bumper above the pivot axis when the grill guard is in the up vertical position in front of the vehicle grill, and such that portions of the vertical guard members below the pivot axis bear against the bumper below the pivot axis when the grill guard is in the lowered position extending horizontally forward from the bumper.

A lock mechanism is provided on the top of the bumper to engage the grill guard when in the vertical position to maintain the grill guard in that position. The grill guard, the bumper, and the pivotal connection between them are structured such that the grill guard is supported sufficiently in both the vertical and horizontal positions that the lock mechanism is not required to resist any rearward forces on the grill guard that would force the grill guard rearward toward the grill being protected. These rearward forces are resisted by the grill guard, the bumper, and the pivotal connection between them. The lock mechanism is only required to prevent the grill guard from pivoting forward, and no significant stress is exerted on the lock mechanism, and same can thus be relatively light and economical, and easily operated to release and engage. The lock mechanism can be provided by an over-centering latch to quickly and easily engage and disengage a catch member mounted on the bumper.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a front perspective view of an embodiment of the grill guard apparatus of the present invention with the grill guard in the raised vertical position;

FIG. 2 is a front perspective view of the embodiment of FIG. 1 with the grill guard in a lowered horizontal position;

FIG. 3 is a schematic side view of the connection of the grill guard to the bumper, with the grill guard in the raised vertical position;

FIG. 4 is a schematic side view of the connection of the grill guard to the bumper, with the grill guard in the lowered horizontal position;

FIG. 5 is an exploded view of a latch for use in maintaining the grill guard in the raised vertical position;

FIG. 6 is a front view of the latch of FIG. 5 with the catch member raised and engaged in the catch rod mounted to the bumper;

FIG. 7 is a side view of the latch of FIG. 5 with the catch member raised and engaged in the catch rod mounted to the bumper;

FIG. 8 is a front view of the latch of FIG. 5 with the catch member lowered and disengaged from the catch rod mounted to the bumper;

FIG. 9 is a schematic side view of an alternate configuration of the connection of the grill guard to the bumper, with the grill guard in the raised vertical position;

FIG. 10 is a schematic side view of the alternate configuration of FIG. 9, with the grill guard in the lowered horizontal position.

### DETAILED DESCRIPTION OF THE ILLUSTRATED EMBODIMENTS

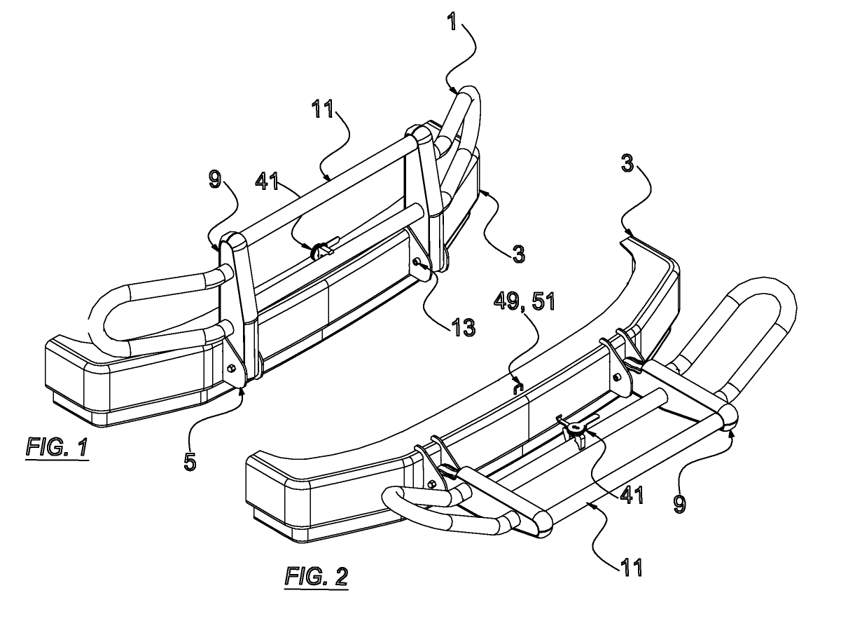

FIGS. 1 and 2 illustrate a grill guard apparatus 1 of the present invention such as would be used on a large vehicle such as a highway tractor. A bumper 3 is attached to the front end of the tractor frame in a conventional manner such that same extends across the lower front portion of the tractor below the tractor's grill. Right and left pivot brackets 5 are welded to the middle portion of the bumper 3.

A grill guard 7 comprises right and left vertical guard members 9 and upper and lower horizontal guard members 11. The grill guard 7 is pivotally attached to the bumper 3 by pivot pins 13 extending through pivot holes defined by the brackets 5 and through corresponding pivot holes in the bottom ends of corresponding right and left vertical guard members 9 of the grill guard 7. The grill guard 7 can thus pivot about a horizontal pivot axis PA that is defined by the pivot pins 13 from the vertical raised position of FIG. 1 to the horizontal lowered position of FIG. 2.

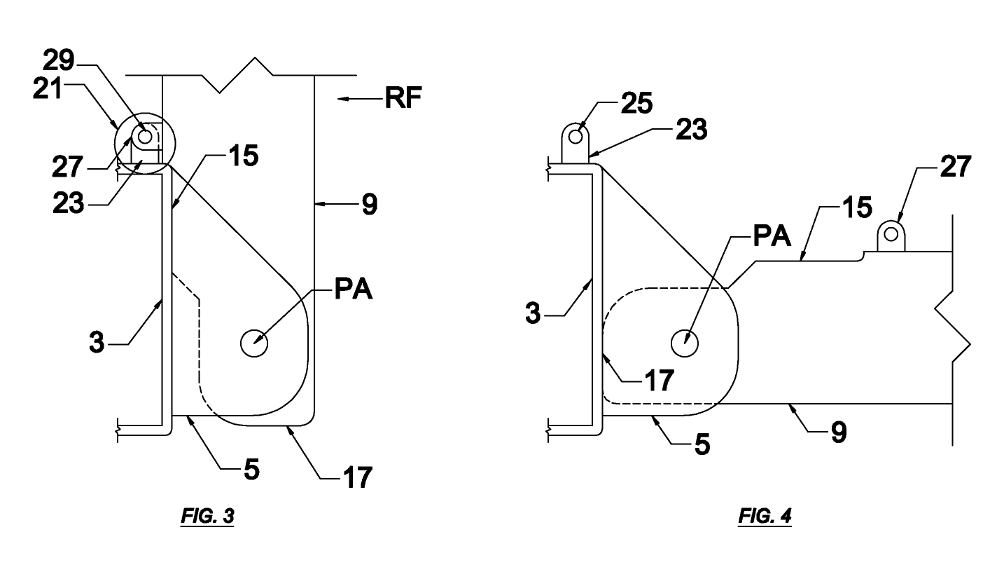

The bottom ends of the vertical guard members 9 and the pivot brackets 5 are configured and oriented with respect to the bumper 3 as schematically illustrated in FIGS. 3 and 4 where the brackets 5 are shown in dotted lines. Upper bearing portions 15 of the vertical guard members 9 that are above the pivot axis PA bear against the bumper 3 above the pivot axis when the grill guard is in the raised vertical position in front of the vehicle grill, as illustrated in FIG. 3.

When the grill guard is lowered to the horizontal position of FIG. 4, lower bearing ends 17 of the vertical guard members 9 that are below the pivot axis PA bear against the bumper 3 below the pivot axis PA to prevent further downward movement of the grill guard 7 and hold the grill guard 7 in the lowered position extending horizontally forward from the bumper 3.

A lock mechanism 21 is provided on the top of the bumper 3 to engage the grill guard 7 when in the vertical position of FIG. 3 to maintain the grill guard 7 in that position. The grill guard 7, the bumper 3, and the pivotal connection between them through the pivot brackets 5 are all structured robustly such that the grill guard 7 is well supported in both the vertical and horizontal positions. The lock mechanism 21 is therefore not required to resist any rearward forces RF on the grill guard 7 that would force the grill guard 7 rearward toward the grill being protected. These rearward forces RF are resisted by the upper bearing portions 15 of the vertical guard members 9 that are above the pivot axis PA grill guard bearing against the bumper 3. The lock mechanism 21 is only required to prevent the grill guard 7 from pivoting forward and downward away from the raised position, and thus no significant stress is exerted on the lock mechanism 21, and same can thus be relatively light and economical, and easily operated to release and engage.

The lock mechanism 21 in FIGS. 3 and 4 is provided simply by a bar 23 welded to the center of the bumper 3 and extending upward, with a pin hole 25 defined in the top end. Corresponding flanges 27 are welded to a horizontal cross member 11 of the grill guard 7 at the center of the grill guard 7, and a pin 29 is inserted through holes in the flanges 27 and through the pin hole 25 to keep the grill guard in the raised vertical position of FIG. 3.

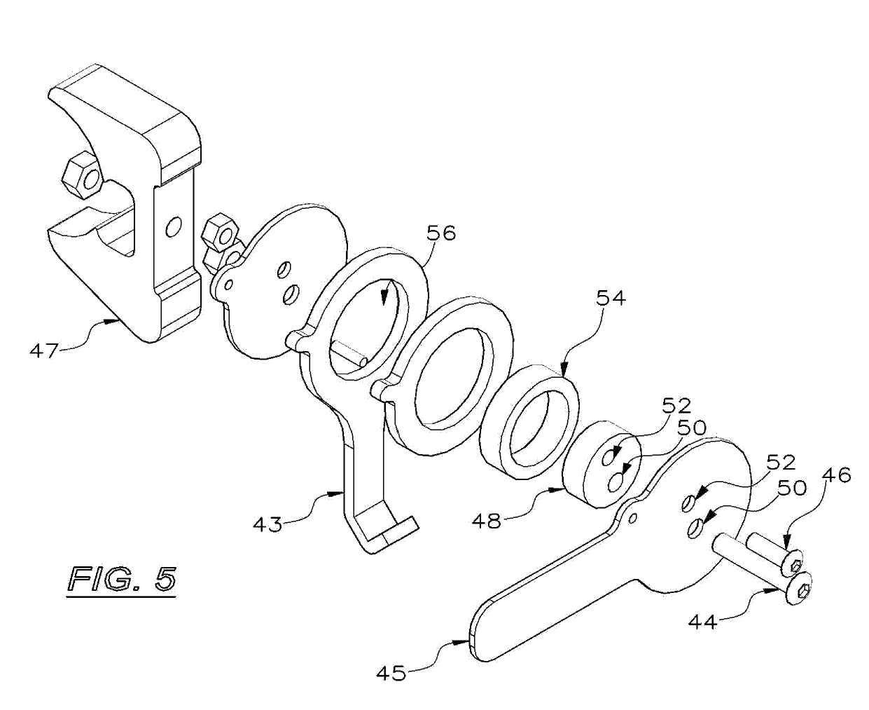

Alternatively a latch can be used to provide the lock mechanism, such as is shown in FIGS. 5-8. The latch 41 is also shown mounted on the grill guard 7 in FIGS. 1 and 2. The latch 41 comprises a downward extending catch member 43 and a rotatable handle 45 mounted to a block 47. The handle 45 and bushing 48 rotate about bolt 44 through bolt holes 50, and the catch member 43 is connected to an eccentric pin 46 extending through pin holes 52 in the handle 45 and bushing 48. The pin holes 52 are off set radially from the bolt holes 50. The bushing 48 is rotatably fitted inside a spacer 54 which in turn is rotatably fitted inside a central aperture 56 of the catch member 43. Rotating the handle 45 about the bolt 44 rotates the bushing 48 about the bolt 44 and raises or lowers the eccentric pin 46 and bushing 48, and thus the catch member 43.

The block 47 is configured to conform to one of the horizontal guard members 11, and to be welded to the center of the lower horizontal guard member 11 as can be seen in FIG. 2. A corresponding horizontal catch rod 49 is mounted to the bumper, and in the illustrated embodiment is conveniently provided by a U-bolt 51 mounted to holes in the top of the bumper 3.

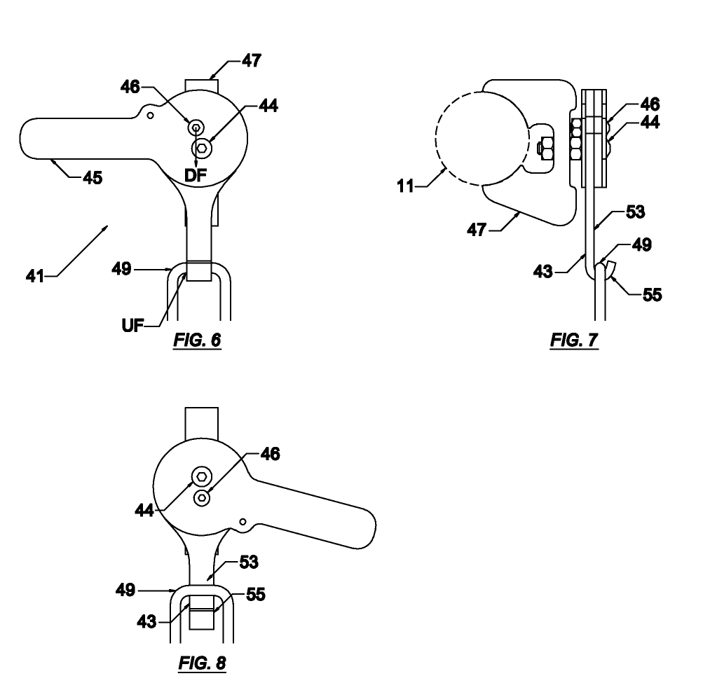

The latch 41 is configured as illustrated in FIG. 5 such that when the handle 45 is in the position of FIG. 8, the catch member 43 is in a lowered position so that when the grill guard is raised to the vertical position of FIG. 1, the face 53 of the catch member 43 is adjacent to the catch rod 49 and the lip 55 of the catch member 43 is below the catch rod 49. Rotating the handle 45 to the position of FIGS. 6 and 7 moves the catch member 43 up so that the lip 55 engages the catch rod 49 and prevents the grill guard from moving down. Rotating the handle 45 in the opposite direction releases the catch rod 49.

As the handle 45 is rotated the eccentric pin 46 moves up and over the rotational axis of the handle 45 at bolt 44, and then slightly down as illustrated in FIG. 6. This over centering action maintains the latch 41 in the closed position. The latch member 43 and catch rod 49 are positioned such that when the lip 55 is engaged on the rod 49 as in FIG. 6, the lip 55 exerts an upward force UF on the catch rod 49, and thus a downward force DF is exerted on the handle 45 at the eccentric pin 46 which keeps the handle 45 from rotating upward in FIG. 6.

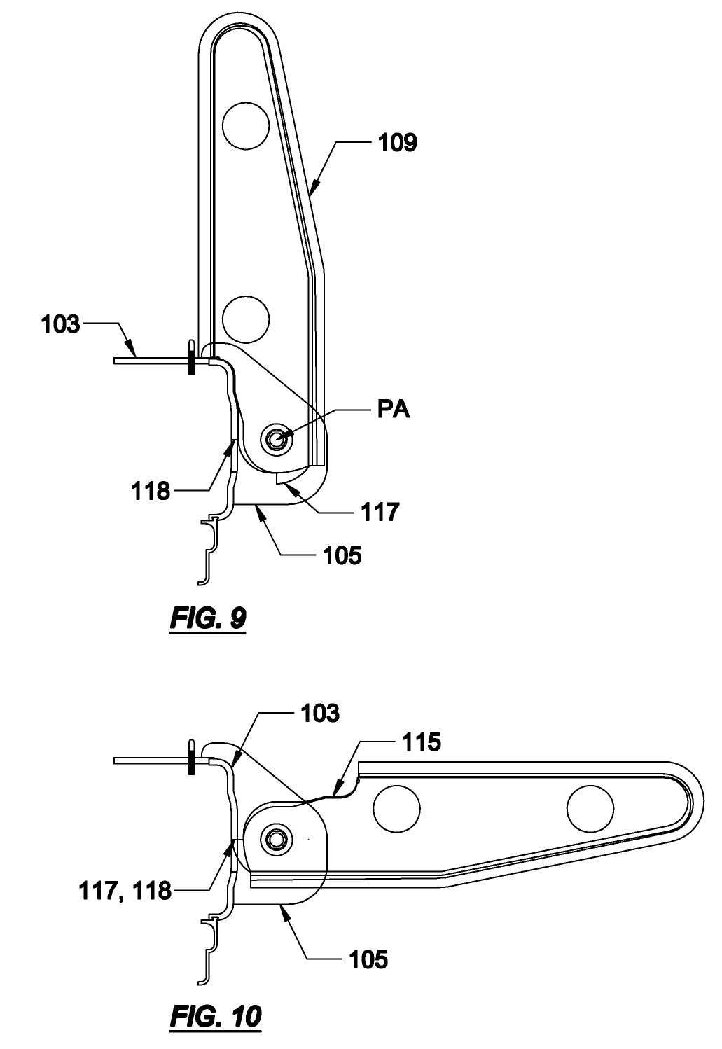

FIGS. 9 and 10 illustrate an alternate configuration of the bottom ends of the vertical guard members 109, the pivot brackets 105, and bumper 103. Upper bearing portions 115 of the vertical guard members 109 that are above the pivot axis PA bear against the bumper 103 above the pivot axis PA when the grill guard is in the raised vertical position in front of the vehicle grill, as illustrated in FIG. 9.

When the grill guard is lowered to the horizontal position of FIG. 10, lower bearing ends 117 of the vertical guard members 109 that are below the pivot axis PA engage apertures 118 in the bumper 103 to prevent further downward movement of the grill guard and hold the grill guard in the lowered position extending horizontally forward from the bumper 103.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A grill guard apparatus for attachment to a bumper of a vehicle to protect a grill of the vehicle, the apparatus comprising:
a grill guard adapted to be pivotally attached at a bottom portion thereof to the bumper about a substantially horizontal pivot axis such that the grill guard can pivot about the pivot axis from an upright raised position in front of the vehicle grill to a lowered position extending substantially horizontally forward from the bumper;
wherein the pivot axis is located vertically between top and bottom edges of the bumper and the grill guard is configured such that portions of the grill guard above the pivot axis bear against the bumper above the pivot axis when the grill guard is in the raised position, and such that portions of the grill guard below the pivot axis bear against the bumper below the pivot axis when the grill guard is in the lowered position and thereby support the grill guard in the lowered position; and
a lock mechanism operative to maintain the grill guard in the raised position.

2. The apparatus of claim 1 wherein the pivot axis is provided by right and left pivot brackets adapted to be fixed to the bumper, and right and left pivot pins extending through substantially horizontally oriented apertures in corresponding right and left pivot brackets and the grill guard.

3. The apparatus of claim 2 wherein the grill guard comprises right and left vertical guard members and wherein the right pivot pin extends through a bottom end of the right vertical guard member and the right pivot bracket, and the left pivot pin extends through a bottom end of the left vertical guard member and the left pivot bracket.

4. The apparatus of claim 3 wherein the pivot brackets and vertical guard members are configured such that portions of the vertical guard members above the pivot axis bear against the bumper above the pivot axis when the grill guard is in the raised position, and such that portions of the vertical guard members below the pivot axis bear against the bumper below the pivot axis when the grill guard is in the lowered position.

5. The apparatus of claim 4 wherein lower ends of the vertical guard members engage corresponding apertures in the bumper.

6. The apparatus of claim 1 wherein the grill guard, the bumper, and the pivotal connection between them are structured such that when the grill guard is in the raised position, any rearward forces on the grill guard toward the grill are resisted by the portions of the grill guard above the pivot axis bearing against the bumper.

7. The apparatus of claim 1 wherein the lock mechanism is operative to prevent the grill guard from pivoting forward and downward away from the raised position.

8. The apparatus of claim 7 wherein the lock mechanism comprises a first lock portion adapted to be mounted to the bumper and a second lock portion attached to the grill guard, and wherein the first and second lock portions are configured to selectively engage when the grill guard is in the raised position.

9. The apparatus of claim 8 wherein the grill guard comprises horizontal guard members and wherein the first lock portion comprises a catch rod and the second lock portion comprises a latch mechanism mounted on a horizontal guard member and operative to selectively engage and disengage the catch rod when same is mounted on the bumper.

10. The apparatus of claim 9 wherein the latch mechanism comprises a downward extending catch member and a rotatable handle configured such that when the handle is in an open position, the catch member is in a lowered position such that when the grill guard is in the raised position, a face of the catch member is adjacent to the catch rod and a lip of the catch member is below the catch rod, and such that when the handle is rotated to a locked position, the catch member moves up so that the lip engages the catch rod.

11. The apparatus of claim 10 wherein the handle and the catch member are connected eccentrically such that as the handle is rotated from the open to the locked position, the catch member moves up into contact with the catch rod and then slightly down in an over centering action wherein the catch member exerts an upward force on the catch rod and a downward force on the handle when the handle is in the locked position such that the handle is prevented from moving upward out of the locked position.

12. The apparatus of claim 11 wherein the latch mechanism comprises:
a block adapted to be attached to the horizontal guard member;
a central aperture through the catch member, and a bushing rotatably fitted inside the central aperture;
a bolt extending through bolt holes in the handle and bushing and into the block such that the handle and bushing can be rotated about the bolt; and
an eccentric pin extending through pin holes in the handle and bushing, wherein the pin holes are off set radially from the bolt holes such that rotating the handle about the bolt raises and lowers the catch member.

13. A grill guard apparatus for a vehicle to protect a grill of the vehicle, the apparatus comprising:
a bumper attached to the front end of the vehicle such that same extends across the lower front portion of the vehicle below the grill;
a grill guard pivotally attached at a bottom portion thereof to the bumper about a substantially horizontal pivot axis located vertically between top and bottom edges of the bumper such that the grill guard can pivot about the pivot axis from an upright raised position in front of the vehicle grill to a lowered position extending substantially horizontally forward from the bumper;
wherein the grill guard is configured such that portions of the grill guard above the pivot axis bear against the bumper above the pivot axis when the grill guard is in the raised position, and such that portions of the grill guard below the pivot axis bear against the bumper below the pivot axis when the grill guard is in the lowered position and thereby support the grill guard in the lowered position;
a lock mechanism operative to maintain the grill guard in the raised position.

14. The apparatus of claim 13 wherein the grill guard comprises right and left vertical guard members and the pivot axis is provided by right and left pivot brackets fixed to the bumper, and right and left pivot pins extending through substantially horizontally oriented apertures through corresponding right and left pivot brackets and through lower portions of the corresponding right and left vertical guard members.

15. The apparatus of claim 14 wherein the pivot brackets and vertical guard members are configured such that portions of the vertical guard members above the pivot axis bear against the bumper above the pivot axis when the grill guard is in the raised position, and such that portions of the vertical guard members below the pivot axis bear against the bumper below the pivot axis when the grill guard is in the lowered position.

16. The apparatus of claim 13 wherein the grill guard, the bumper, and the pivotal connection between them are structured such that when the grill guard is in the raised position, any rearward forces on the grill guard toward the grill are resisted by the portions of the grill guard above the pivot axis bearing against the bumper.

17. The apparatus of claim 13 wherein the lock mechanism comprises a substantially horizontal catch rod mounted to the bumper and a latch mechanism mounted to the grill guard and operative to selectively engage and disengage the catch rod when same is mounted on the bumper.

18. The apparatus of claim 17 wherein the latch mechanism comprises a downward extending catch member and a rotatable handle configured such that when the handle is in an open position, the catch member is in a lowered position such that when the grill guard is in the raised position, a face of the catch member is adjacent to the catch rod and a lip of the catch member is below the catch rod, and such that when the handle is rotated to a locked position, the catch member moves up so that the lip engages the catch rod.

19. The apparatus of claim 18 wherein the handle and the catch member are connected eccentrically such that as the handle is rotated from the open to the locked position, the catch member moves up into contact with the catch rod and then slightly down in an over centering action wherein the catch member exerts an upward force on the catch rod and a downward force on the handle when the handle is in the locked position such that the handle is prevented from moving upward out of the locked position.

20. The apparatus of claim 19 wherein the latch mechanism comprises:
a block adapted to be attached to the horizontal guard member;
a central aperture through the catch member, and a bushing rotatably fitted inside the central aperture;
a bolt extending through bolt holes in the handle and bushing and into the block such that the handle and bushing can be rotated about the bolt; and
an eccentric pin extending through pin holes in the handle and bushing, wherein the pin holes are off set radially from the bolt holes such that rotating the handle about the bolt raises and lowers the catch member.

21. A lock apparatus for locking a first member to a second member, the apparatus comprising:
a catch rod mounted to the first member; and
a latch mechanism mounted to the second member;
wherein the latch mechanism comprises a catch member and a rotatable handle configured such that when the handle is in an open position, the catch member is in an open position with a face of the catch member adjacent to the catch rod and a lip of the catch member is located on a side of the catch rod opposite to the latch mechanism, and configured such that when the handle is rotated to a locked position, the catch member moves toward the latch mechanism so that the lip engages the catch rod.

22. The apparatus of claim 21 wherein the handle and the catch member are connected eccentrically such that as the handle is rotated from the open to the locked position, the catch member moves toward the latch mechanism and into contact with the catch rod and then moves away from the latch mechanism in an over centering action wherein the catch member exerts a force on the catch rod and the handle when the handle is in the locked position such that the handle is prevented from moving upward out of the locked position.

23. The apparatus of claim 22 wherein the latch mechanism comprises:
a block adapted to be attached to the second member;
a central aperture through the catch member, and a bushing rotatably fitted inside the central aperture;
a bolt extending through bolt holes in the handle and bushing and into the block such that the handle and bushing can be rotated about the bolt; and
an eccentric pin extending through pin holes in the handle and bushing, wherein the pin holes are off set radially from the bolt holes such that rotating the handle about the bolt raises and lowers the catch member.

24. The apparatus of claim 21 wherein one of the first and second members is a grill guard and the other of the first and second members is a vehicle bumper.
